(19) United States
(12) Patent Application Publication
(10) Pub. No.: US 2019/0362051 A1
(43) Pub. Date: Nov. 28, 2019

(54) MANAGING ACCESS TO A MEDIA FILE

(71) Applicants: Barak Ethan, Kfar Shmaryahu (IL); Gil Rosen, Tel-Mond (IL)

(72) Inventors: Barak Ethan, Kfar Shmaryahu (IL); Gil Rosen, Tel-Mond (IL)

(21) Appl. No.: 16/419,000

(22) Filed: May 22, 2019

Related U.S. Application Data
(60) Provisional application No. 62/674,671, filed on May 22, 2018.

(51) Int. Cl. G06F 21/10; G06F 16/41; G06F 21/62; H04L 9/08; H04L 29/06; G06K 9/00

(52) U.S. Cl. CPC G06F 21/10; G06F 16/41; G06F 21/6209; G06F 2221/0748; H04L 63/10; G06K 9/00288; H04L 9/0894

(57) ABSTRACT

A system, a non-transitory computer readable medium and a method for managing access to a media file. The method may be executed by a computerized system and may include (i) receiving the media file and a decoy media file; wherein the media file is associated with a first user; (ii) encrypting the media file to provide an encrypted media file; wherein the encrypting comprises using an encryption key; (iii) concealing the encrypted media file in the decoy media file to provide a output media file; and (iv) generating or receiving access control information for controlling an access to the media file.

### CROSS REFERENCE

This application claims priority from US provisional patent filing date May 22 2018 and Ser. No. 62/674,671 which is incorporated herein by reference.

### BACKGROUND

There is a growing need to for a cross file format, digital right management (DRM) system for personal and business use.

### SUMMARY

There may be provided a method for managing access to a media file, the method may include receiving, by a computerized system, the media file and a decoy media file; wherein the media file is associated with a first user; encrypting, by the computerized system, the media file to provide an encrypted media file; wherein the encrypting may include using an encryption key; concealing the encrypted media file in the decoy media file to provide a output media file; and generating or receiving access control information for controlling an access to the media file.

The concealing may include applying a steganography process.

The method may include receiving, by the computerized system, a request from a second user to access the media file; determining, based on the access control information, whether the second user has an access right to the media file; wherein when determining that the second user does not have the access right to the media file, sending to the second user the decoy media file; and wherein when determining that the second user has the access right to the media file then (i) extracting the encrypted media file from the output media file, (ii) decrypting the encrypted media file to provide the media file, and (iii) sending the media to the second user.

The method may include sending to the second user a trigger for requesting access to the media file, when the second user does not have the access right to the media file.

An access right to the media file may be time limited and wherein the determining may include checking whether an access right granted to the second user is still valid at a time of the receiving of the request and/or still valid at the expected time of an intended provision of the media file to the second user.

The method may include detecting, in the media file and by the computerized system, a representation of another user; and requesting the first user to grant access right to the media file to the other user. The media file may include at least one image and wherein the detecting may include applying face recognition to detect a face of the other user.

The method may include comparing a size of the media file to a size of the decoy media file; and wherein when the size of the decoy media file is smaller than the size of the media file then and changing a size of at least one of the media file and the decoy file to provide a media file of a size that does not exceed a size of the decoy media file. The changing of the size may be dependent upon a quality level of at least one of the media file and the decoy media file.

The method may include storing the encrypted key in a database and storing the output media file in another database.

The method may include generating, by the computerized system, a media file identifier and embedding the media file identifier in the output media file.

There may be provided a non-transitory computer readable medium may store instructions for receiving, by a computerized system, the media file and a decoy media file; wherein the media file is associated with a first user; encrypting, by the computerized system, the media file to provide an encrypted media file; wherein the encrypting may include using an encryption key; concealing the encrypted media file in the decoy media file to provide a output media file; and generating or receiving access control information for controlling an access to the media file.

The non-transitory computer readable medium may store instructions for receiving, by the computerized system, a request from a second user to access the media file; determining, based on the access control information, whether the second user has an access right to the media file; wherein when determining that the second user does not have the access right to the media file, sending to the second user the decoy media file; and wherein when determining that the second user has the access right to the media file then (i) extracting the encrypted media file from the output media file, (ii) decrypting the encrypted media file to provide the media file, and (iii) sending the media to the second user.

The non-transitory computer readable medium may store instructions for sending to the second user a trigger for requesting access to the media file, when the second user does not have the access right to the media file.

The access right to the media file may be time limited and wherein the non-transitory computer readable medium stores instructions for checking whether an access right granted to the second user is still valid at a time of the receiving of the request.

The non-transitory computer readable medium may store instructions for detecting, in the media file and by the computerized system, a representation of another user; and requesting the first user to grant access right to the media file to the other user.

The media file may include at least one image and wherein the detecting may include applying face recognition to detect a face of the other user.

The non-transitory computer readable medium may store instructions for comparing a size of the media file to a size of the decoy media file; and wherein when the size of the decoy media file is smaller than the size of the media file then and changing a size of at least one of the media file and the decoy file to provide a media file of a size that does not exceed a size of the decoy media file.

The changing of the size may be dependent upon a quality level of at least one of the media file and the decoy media file.

The non-transitory computer readable medium may store instructions for storing the encrypted key in a database and storing the output media file in another database.

The non-transitory computer readable medium may store instructions for generating, by the computerized system, a media file identifier and embedding the media file identifier in the output media file.

There may be provided a computerized system that may include a communication module, a processor, and a memory unit; wherein the communication module is configured to receive the media file and a decoy media file; wherein the media file is associated with a first user; wherein the processor is configured to encrypt the media file to provide an encrypted media file; wherein the encrypting may include using an encryption key; conceal the encrypted media file in the decoy media file to provide a output media file; and generate or receive access control information for controlling an access to the media file.

The communication module may be configured to receive a request from a second user to access the media file. The processor may be configured to determine, based on the access control information, whether the second user has an access right to the media file. When determining that the second user does not have the access right to the media file, the communication module is configured to send to the second user the decoy media file. When determining that the second user has the access right to the media file then the processor is configured to (i) extract the encrypted media file from the output media file, and (ii) decrypt the encrypted media file to provide the media file, and the communication module is configured to send the media to the second user.

The communication module may be configured to send to the second user a trigger for requesting access to the media file, when the second user does not have the access right to the media file.

An access right to the media file may be time limited and the processor may be configured to determine whether the second user has an access right by checking whether an access right granted to the second user is still valid at a time of the receiving of the request and/or still valid at the expected time of an intended provision of the media file to the second user.

The processor may be configured to detect in the media file a representation of another user (for example an image of a face of the other user, a sound made by the second user), and the communication module may be configured to request the first user to grant access right to the media file to the other user. The media file may include at least one image and the processor may be configured to detect a face of the other user by applying face recognition.

The processor may be configured to compare a size of the media file to a size of the decoy media file; and wherein when the size of the decoy media file is smaller than the size of the media file then change a size of at least one of the media file and the decoy file to provide a media file of a size that does not exceed a size of the decoy media file. The changing of the size may be dependent upon a quality level of at least one of the media file and the decoy media file.

The memory unit may be configured to store the encrypted key in a database and store the output media file in another database.

The processor may be configured to generate a media file identifier and embed the media file identifier in the output media file.

### BRIEF DESCRIPTION OF THE DRAWINGS

In order to understand the invention and to see how it may be carried out in practice, a preferred embodiment will now be described, by way of non-limiting example only, with reference to the accompanying drawings:

FIG. 1 is an example of a method;

FIG. 2 is an example of a method; and

FIG. 3 is an example of a computerized system and one or more user devices.

### DETAILED DESCRIPTION OF THE DRAWINGS

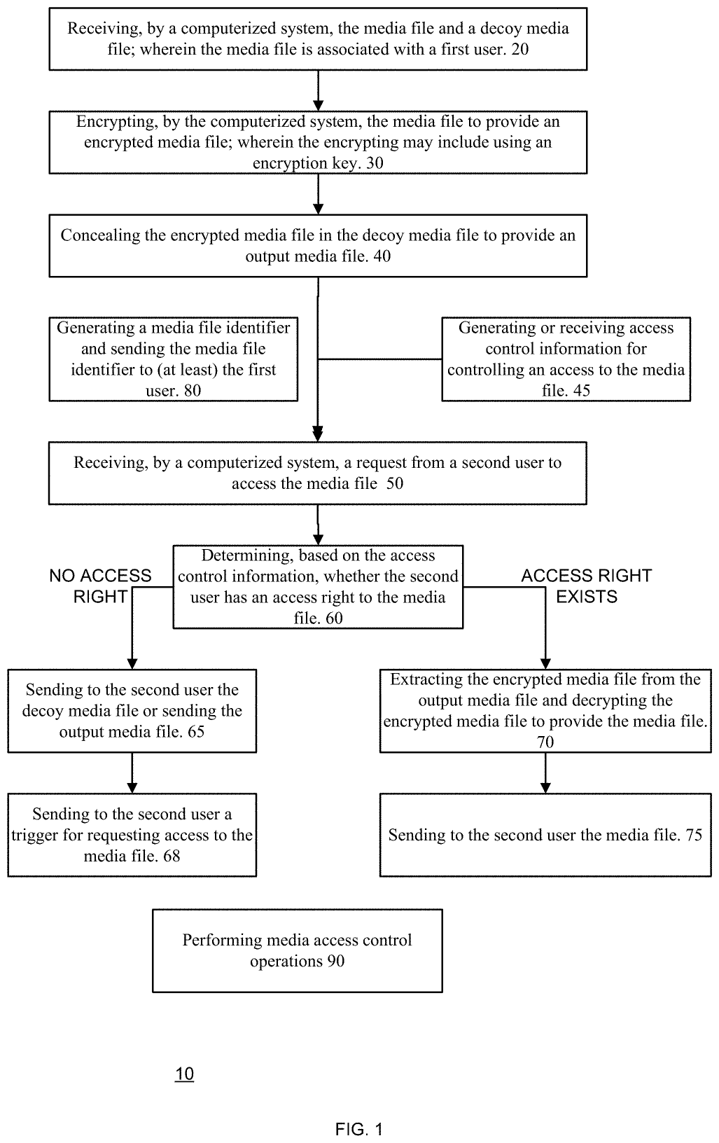

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which FIG. 1 is a diagram of a method.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a device capable of executing the method and should be applied mutatis mutandis to a non-transitory computer readable medium that stores instructions that once executed by a computer result in the execution of the method.

Any reference in the specification to a device should be applied mutatis mutandis to a method that may be executed by the device and should be applied mutatis mutandis to a non-transitory computer readable medium that stores instructions that may be executed by the device.

Any reference in the specification to a non-transitory computer readable medium should be applied mutatis mutandis to a device capable of executing the instructions stored in the non-transitory computer readable medium and should be applied mutatis mutandis to method that may be executed by a computer that reads the instructions stored in the non-transitory computer readable medium.

There is provided a method, a system and a computer readable medium that is non-transitory and stores commands to be executed by a computerized system (hereinafter “system”).

There is provided a system that is a personal digital rights management (DRM) system that can be managed by a user that is equipped with a user device such as computerized communication device (smart phone, laptop computer, wearable computer, desktop computer, tablet and the like).

The system allows users encode their media file (one or more photos, one or more videos, one or more media file of any format such as PDF format, WORD format, MP3 format and the like) by using steganography of the original media and a decoy media file (one or more photos, one or more videos, one or more media file of any format such as PDF format, WORD format, MP3 format and the like).

For simplicity of explanation it is assumed that the media file is a single image and the decoy media file is a single decoy image. Any reference to a photo or image should be applied mutatis mutandis to any other media file.

The method starts by having the user select a first photo which is the secret photo that he wishes to secure and a second photo which is the decoy photo visible to all and sends it to the system which disassembles the secret photo into bytes (or other data units) and spread it in the decoy photo using a steganography process to provide a output photo. The disassembling may be applied while keeping the format of the decoy photo.

The system may include one or more computers. For simplicity of explanation it is assumed that the one or more computers may include one or more servers (also referred to as a security server). The computerized system may be within a cloud computing environment—but this is not necessarily so.

The user device and the system may communicate using any type of links, networks and/or channels.

In the following text it is assumed that the user device communicated with a server of the system. The following text also mentions various protocols, security measures, messages, file formats, compression algorithms, and other details may be provided—they are merely non-limiting examples.

Security

All the requests to the server may be protected with SSL (a cryptographic protocols that provide communications security over a computer network, https://en.wikipedia.org/wiki/Transport_Layer_Security) transport and a JWT (JSON Web Token) that is a JSON-based open standard (RFC 7519) for creating access tokens that assert some number of claims, https://en.wikipedia.org/wiki/json_web_token) token.

The system can protect any type of media filed—not just photos.

The Creation of a New Secured Photo

The user should select a secret photo (previously referred to a first photo) which he wishes to secure using any input (camera, photo gallery or from any other source) then after selecting the secret photo the user should choose a decoy photo using any option (Camera, Gallery, pixelate the secret photo, choose from a photo collections or create a note. A note is any color background with text upon) or from any other source.

Then after the user provides the decoy photo and the secret photo the user device uploads them (Post HTTPS or Socket) to the server using SSL and a JWT token that was generated for the user when the user logged in (this token may be the only way to communicate with the server and be known) in a fast and secure way.

The server receives the two photos and compare the sizes of the secret photo and the decoy photo by first checking if the decoy photo size is equal or bigger than the size of the secret photo. If not the (a) shrink the secret photo if the decoy is of a low/medium quality, or (b) scale up the decoy photo if the secret photo is of a low/medium quality. The image scaling may include resizing a photo.

If the decoy photo is equal or bigger then the secret photo (either initially of after the server manipulates the photos) it generates a key. The key may be generated using a random key generator—such as a software program that runs on a hardware device—or hardware device that takes input from a random or pseudo-random number generator and automatically generates a key. Random keys can be generated manually, using simple sources of randomness such as dice or coins, or they can be generated using a computer, https://en.wikipedia.org/wiki/Random_password_generator).

The server may then encrypt the secret photo (using the key) to provide an encrypted file.

The encryption may include scrumbling the bytes of the encrypted file using the key and AES—The Advanced Encryption Standard (AES), also known by its original name Rijndael is a specification for the encryption of electronic data established by the U.S. National Institute of Standards and Technology (NIST) in 2001, https://en.wikipedia.org/wiki/Advanced_Encryption_Standard).

The server may then compress the encrypted file to provide a compressed. Any compression process may be used (lossless or lossy). For example—the server may compresses the encrypted file to provide a compressed file having a Gzip format or any other format.

The compressed file (if compression was applied) or the encrypted file (if compression was not applied) may be concealed in the decoy media file to provide an output media file.

The concealing may involve applying a steganography process.

Steganography is the practice of concealing a file, message, image, or video within another file, message, image, or video.

The steganography may include LSB bit numbering (Least Significant Bit—In computing, bit numbering (or sometimes bit endianness) is the convention used to identify the bit positions in a binary number or a container for such a value. The bit number starts with zero and is incremented by one for each subsequent bit position, https://en.wikipedia.org/wiki/Bit_numbering) algorithm keeping high performance and low memory usage.

The output file may be saved in a database. The output file may be split to chunks into multiple storage unit regions so in an act of bridge it would be very difficult to find the data pieces (https://en.wikipedia.org/wiki/Database_storage_structures).

The server may also encode the key to provide an encrypted key.

Furthermore, since the server encrypts and scrambles the secret photo it is extremely difficult to decrypt the secret photo from the decoy photo. The server may save the encrypted key (or metadata regarding the key) in another secure database after encoding the key. The encoding may be applied in various manners—for example—by using another key that may be based on an email or the user and a timestamp that the user created his account. The other key (used for encrypting the key used to encrypt the secret photo) may us based in any manner—for example used during a SHA-2 algorithm (SHA-2 (Secure Hash Algorithm 2) is a set of cryptographic hash functions designed by the United States National Security Agency (NSA), https://en.wikipedia.org/wiki/SHA-2).

The server also may generate and output a photo identifier that identifies the secret phot/output file generated based on the secret photo and the decoy photo.

Providing a Permission to a Photos Inside the System Environment

Assuming that a user is at least regarded as an entity that may provide access rights to other users for accessing a secret photo (having an identifier photo_ID). The user may wish to share the secret photo with another user (for example—another user registered to the service that generates the output files). The user then sends a request to the server with the photo identifier and an identifier (user_ID) of the other user. The Server may update the access control information to indicate that the other user may access the secret photo.

For example—the server may create a record in a ‘shareWith’ collection connecting (Edge) the user_ID with the photo ID (a graph database—In computing, a graph database (GDB) is a database that uses graph structures for semantic queries with nodes, edges and properties to represent and store data. The graph (or edge or relationship), which directly relates data items in the store, and sends a notification to the other user.

The other user gets the notification and an application hosted on the other user device may fetch a feed for retrieving the output file or the secret file.

When the user requests to retrieve the secret file (for example by clicking the feed) the application sends a permission query to the server asking if the other user still has view permissions. If so the server fetches the output file bytes (associated with Photo ID) from a storage database, extract the encrypted (or compressed) file from the encrypted file and decrypt the encrypted file (if no compression was applied) or decompresses the compressed file to provide the encrypted file and the decrypt the encrypted file. In both cases the outcome is the secret photo. The secret photo may be sent to the other user.

The application client may provide a view for only a certain time period (for example 1 till 20 minutes—or any other timeframe) before re-checking the access permission of the other user. If the other user lost his access rights (means that the first user removed him from the permissions list) the other user will not receive the secret photo. The user may be asked to request access rights from the owner of the secret photo. If the other user requests a new permission the owner will get a notification and will need to decline or grant this request.

If user a wishes to cancel access rights to another user—the owner may update the access control information accordingly—for example by deleting the name of the other user from a a permissions table.

A Co-Owner

A media file can become owned by more than one user by having the original owner of the secret photo to update the access control information. When there are multiple owners of the same secret phot—the access control may be managed in any manner—every owner may independently grant access rights, at least a certain part of the owners may be required to grant access rights, and the like.

The server may be configured to detect automatically photos with other users (for example user's friends) by using face detection/recognition (Face detection is a computer technology being used in a variety of applications that identifies human faces in digital images) and suggest the owner to grant thse other users a co-ownership.

What can Users that are Approved to View the Photo Do?

Users that are able to view a secret photo (got permissions from the owner) can do any social action on the photo (link, comments, chat, count views, rate, etc.) including sharing it. However according to one example—without the original owner consent, only the decoy photo can be viewed. The receiver of the new decoy photo can send a specific access request to the original owner and receive separate and new view rights. Without receiving the view rights the user has no access to view the original file.

Client Detection of Sensitive MEDIA

The application client can search the user's device photos and provide him with a report of which media files should be processed by the system by using digital image processing and deep learning (also known as deep structured learning or hierarchical learning).

The user can choose at any time or during the search bulk of photos and secure them by auto-selecting decoy from many sources.

How to Share Photo Outside the Network of Registered Users

A photo can be shared with anyone who has a system account (account of the system described in this application) or anyone who doesn't have a system account by any social networks.

The user device may send the decoy photo with a deep link (In the context of the World Wide Web, deep linking is the use of a hyperlink that links to a specific, generally searchable or indexed, piece of web content on a website (e.g., “http://example.com/path/page”), rather than the website's home page (e.g., “http://example.com/”).

If the receiving user (user receiving the deep link) has a system application (application executed by the user device that is configured to communicate with the system) installed it will open in the system application providing a way to ask for permissions. If the user receiving the deep link has no system application installed, the deep link may lead to a download page which will let that user download and install the system app.

After installing the system application the receiving user will be able to see the photo (decoy) in his feed and to ask permissions.

The server may hold each photo_ID in the image file headers (In information technology, header refers to supplemental data placed at the beginning of a block of data being stored or transmitted) so even if social network manipulates the photo when sending the system can always find the source.

How to Change Decoy Photo to a Secured Photo

A user can change the decoy photo of a secured photo in anytime by selecting a new decoy photo and send it to the server with the (old) photo_ID. The server may process the output file to receive the secret photo and generates (using the new decoy photo and the secret phot) a new output file.

How to Create Notes and Tags on a Photo?

A photo owner can create a note on any photo it owns and can be view only by him. The user may also can create tags on a photo which can be searched in the application search area. The user will be able to delete a photo for good and all the shares will be invoked if the user is the only owner. In a case of co-owners, the user that will delete the photo will be removed from the owner list and may not be able to gain back ownership unless another owner will add him again. It will be able to ask for permissions like non-owners users.

How to Protect the Users from an Inappropriate Content?

The users can block users, hide secret photos from their feed and report on a user at any time in the application. If the user can view the blocked/hide list and unblock/unhide. A user that has been reported for a predefined number (for example 3 times) may be suspended from the system and won't be able to log in for a week.

FIG. 1 is an example of method 10.

Method 10 may be executed by a computerized system.

Method 10 may start by step 20 of receiving, by a computerized system, the media file and a decoy media file; wherein the media file is associated with a first user. The first user is an owner of the media file in the sense that he may provide access rights to other users.

Step 20 may be followed by step 30 of encrypting, by the computerized system, the media file to provide an encrypted media file; wherein the encrypting may include using an encryption key.

Step 30 may be followed by step 40 of concealing the encrypted media file in the decoy media file to provide an output media file.

The concealing may include applying a steganography process.

Method 10 may include step 45 of generating or receiving access control information for controlling an access to the media file. For example—the first user may define access rights and the computerized system may add to the access control information the media file identifier. The media file identifier may also be set to the user device of the first user.

Method 10 may also include step 50 of receiving, by the computerized system, a request from a second user to access the media file.

Step 50 may be followed by step 60 of determining, based on the access control information, whether the second user has an access right to the media file.

The access right to the media file may be time limited and step 60 may include checking whether an access right granted to the second user is still valid at a time of the receiving of the request and/or still valid at the expected time of an intended provision of the media file to the second user. If the access right expired then the second user may receive the decoy media file and/or the output media file.

If the second user does not have the access right to the media file then step 60 is followed by step 65 of sending to the second user the decoy media file or sending the output media file.

Step 65 may be followed by step 68 of sending to the second user a trigger for requesting access to the media file, when the second user does not have the access right to the media file. The trigger may appear in a man machine interface—for example in the form of a button.

If the second user has the access right to the media file then step 60 may be followed by:
a. Step 70 of extracting the encrypted media file from the output media file and decrypting the encrypted media file to provide the media file.
b. Step 75 of sending the media file to the second user.

Step 75 may include sending to the second user an image identifier.

Method 10 may include step 80 of generating a media file identifier and sending the media file identifier to (at least) the first user. Step 80 may include embedding the media file identifier in the output media file. The media file identifier may be sent to the user in other manners.

Method 10 may include step 90 of performing media access control operations such as updating the access rights, updating a list of owners, adapting a limited time period associated with an access right to a user that is not an owner, receiving requests regarding to the access rights, informing one or more owners regarding the requests, receiving responses from one or more owners, determining access to a non-owner, and the like.

Step 90 may include, for example, detecting, in the media file and by the computerized system, a representation of another user; and requesting the first user to grant access right to the media file to the other user. The media file may include at least one image and wherein the detecting may include applying face recognition to detect a face of the other user.

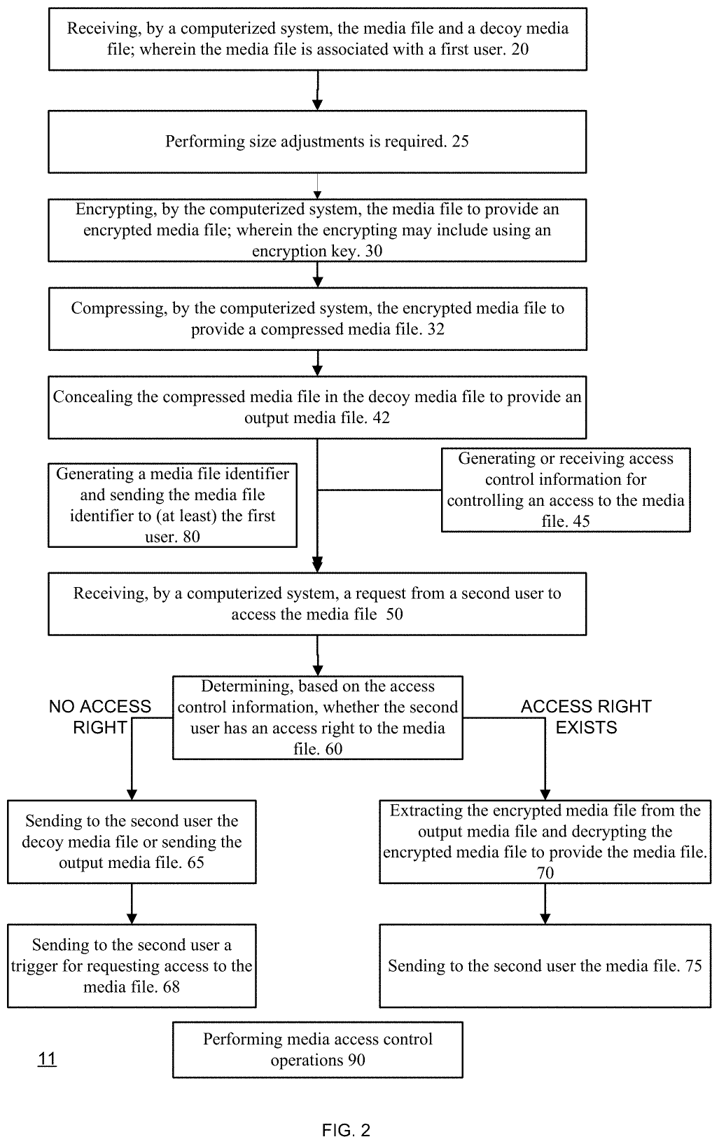

FIG. 2 is an example of a method 11.

Method 11 differs from method 10 by (a) including step 25 after step 20 and before stem 330, (b) having step 32 after step 30, (c) having step 42 instead of step 40.

It should be noted that method 10 may be amended only by including step 25 or only by including steps 32 and 42 (the latter replaces step 40).

Method 10 may start by step 20.

Step 20 may be followed by step 25 of performing size adjustments is required. Step 25 may include comparing a size of the media file to a size of the decoy media file; and wherein when the size of the decoy media file is smaller than the size of the media file then and changing a size of at least one of the media file and the decoy file to provide a media file of a size that does not exceed a size of the decoy media file. The changing of the size may be dependent upon a quality level of at least one of the media file and the decoy media file. A non-limiting example is provided in the text above.

Step 25 may be followed by step 30.

Step 30 may be followed by step 32 of compressing, by the computerized system, the encrypted media file to provide a compressed media file.

Step 32 may be followed by step 42 of concealing the compressed media file in the decoy media file to provide an output media file.

Method 11 may also include other steps of method 100 such as steps 45, 50, 60, 65, 68, 70, 75, 80 and 90.

In any method the owner of the secret media file may receive monetary compensation for granting an access right, and/or for each access to the secret media file. A user requesting an access right and/or a user that has an access right and requests to access a secret media file may be requested to pay for said access right and/or for said access. The payment can be easier to users registered to the services but users that are not registered may be required to provide their payment information in order to access. The user that request access may be directed to a payment manager to arrange the payment. Any known method for paying for access to a content may be applied.

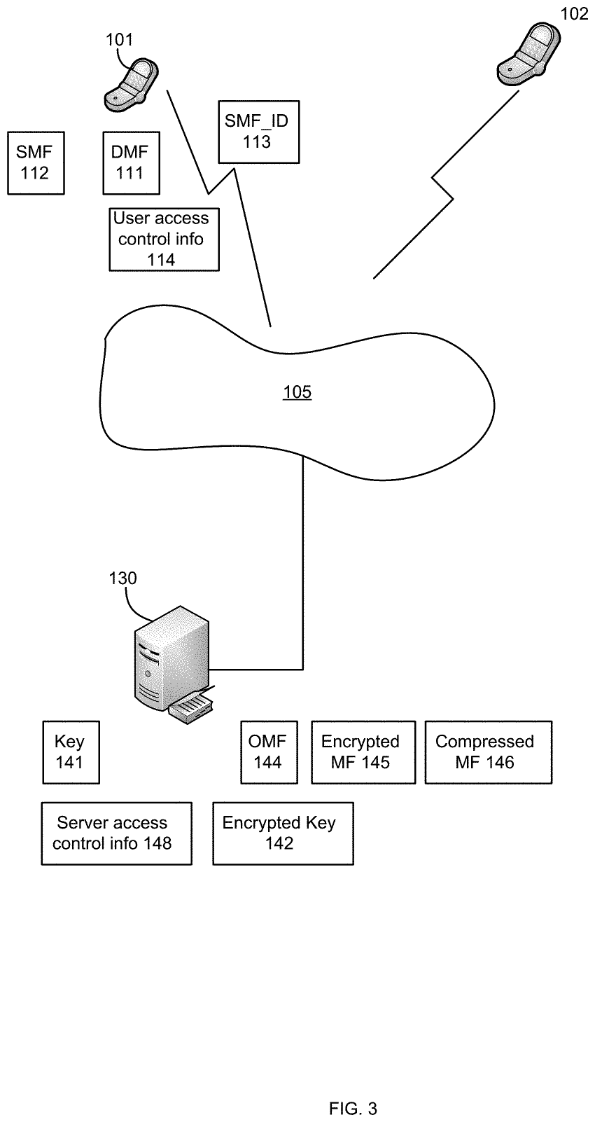

FIG. 3 is an example of a computerized system 130 and one or more user devices 101 and 102.

FIG. 3 illustrates user devices such as smartphones 101 and 102 that are coupled via network 105 to system 130.

In this figure “MF” stands for media file.

It is assumed that the first user is the owner of a secret media file (SMF 112) and sends to the system 150 SMF 112, and decoy media file (DMF) 111. The first user also may define user access control info 114—which defines the access rights to SMF 112 according to the first user.

SMF 112, DMF 111 and user access control info 114 are sent to the system 130 over network.

The system 150 may execute at least one method of methods 10 and 11.

The system may store and/or generate key 141, encrypted key 142, output media file (OMF) 145, compressed media file 146 and server access control information 148. The system may send to first user the SMF ID 113, and may interact with second user in case the second user requests to access SMF 112.

Any processor illustrated or mentioned above may include one or more integrated circuits and may be an ASCI, an FPGA, a CPU, a GPU, and the like. Configured to may be equivalent to constructed and arranged to, programmed to, and the like.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope.

Any reference to the term “comprising” or “having” should be interpreted also as referring to “consisting” of “essentially consisting of”. For example—a method that comprises certain steps can include additional steps, can be limited to the certain steps or may include additional steps that do not materially affect the basic and novel characteristics of the method—respectively.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc. A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system. The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method for managing access to a media file, the method comprises:
receiving, by a computerized system, the media file and a decoy media file; wherein the media file is associated with a first user;
encrypting, by the computerized system, the media file to provide an encrypted media file; wherein the encrypting comprises using an encryption key;
concealing the encrypted media file in the decoy media file to provide a output media file; and
generating or receiving access control information for controlling an access to the media file.

2. The method according to claim 1 comprising:
receiving, by the computerized system, a request from a second user to access the media file;
determining, based on the access control information, whether the second user has an access right to the media file;
wherein when determining that the second user does not have the access right to the media file, sending to the second user the decoy media file; and
wherein when determining that the second user has the access right to the media file then (i) extracting the encrypted media file from the output media file, (ii) decrypting the encrypted media file to provide the media file, and (iii) sending the media file to the second user.

3. The method according to claim 2 comprising sending to the second user a trigger for requesting access to the media file, when the second user does not have the access right to the media file.

4. The method according to claim 2 wherein an access right to the media file is time limited and wherein the determining comprises checking whether an access right granted to the second user is still valid at a time of the receiving of the request.

5. The method according to claim 1 comprising detecting, in the media file and by the computerized system, a representation of another user; and requesting the first user to grant access right to the media file to the other user.

6. The method according to claim 5 wherein the media file comprises at least one image and wherein the detecting comprises applying face recognition to detect a face of the other user.

7. The method according to claim 1 comprising:
comparing a size of the media file to a size of the decoy media file;
and wherein when the size of the decoy media file is smaller than the size of the media file then and changing a size of at least one of the media file and the decoy file to provide a media file of a size that does not exceed a size of the decoy media file.

8. The method according to claim 7 wherein the changing of the size is dependent upon a quality level of at least one of the media file and the decoy media file.

9. The method according to claim 1 comprising storing the encrypted key in a database and storing the output media file in another database.

10. The method according to claim 1 comprising generating, by the computerized system, a media file identifier and embedding the media file identifier in the output media file.

11. A non-transitory computer readable medium that stores instructions for:
receiving, by a computerized system, the media file and a decoy media file; wherein the media file is associated with a first user;
encrypting, by the computerized system, the media file to provide an encrypted media file; wherein the encrypting comprises using an encryption key;
concealing the encrypted media file in the decoy media file to provide a output media file; and
generating or receiving access control information for controlling an access to the media file.

12. The non-transitory computer readable medium according to claim 11 that stores instructions for:
receiving, by the computerized system, a request from a second user to access the media file;
determining, based on the access control information, whether the second user has an access right to the media file;
wherein when determining that the second user does not have the access right to the media file, sending to the second user the decoy media file; and
wherein when determining that the second user has the access right to the media file then (i) extracting the encrypted media file from the output media file, (ii) decrypting the encrypted media file to provide the media file, and (iii) sending the media to the second user.

13. The non-transitory computer readable medium according to claim 12 that stores instructions for sending to the second user a trigger for requesting access to the media file, when the second user does not have the access right to the media file.

14. The non-transitory computer readable medium according to claim 12 wherein an access right to the media file is time limited and wherein the non-transitory computer readable medium stores instructions for checking whether an access right granted to the second user is still valid at a time of the receiving of the request.

15. The non-transitory computer readable medium according to claim 11 that stores instructions for detecting, in the media file and by the computerized system, a representation of another user; and requesting the first user to grant access right to the media file to the other user.

16. The non-transitory computer readable medium according to claim 14 wherein the media file comprises at least one image and wherein the detecting comprises applying face recognition to detect a face of the other user.

17. The non-transitory computer readable medium according to claim 11 that stores instructions for:
comparing a size of the media file to a size of the decoy media file;
and wherein when the size of the decoy media file is smaller than the size of the media file then and changing a size of at least one of the media file and the decoy file to provide a media file of a size that does not exceed a size of the decoy media file.

18. The non-transitory computer readable medium according to claim 16 wherein the changing of the size is dependent upon a quality level of at least one of the media file and the decoy media file.

19. The non-transitory computer readable medium according to claim 11 that stores instructions for storing the encrypted key in a database and storing the output media file in another database.

20. The non-transitory computer readable medium according to claim 11 that stores instructions for generating, by the computerized system, a media file identifier and embedding the media file identifier in the output media file.

21. A computerized system that comprises a communication module, a processor, and a memory unit; wherein the communication module is configured to receive the media file and a decoy media file; wherein the media file is associated with a first user; wherein the processor is configured to: encrypt the media file to provide an encrypted media file; wherein the encrypting comprises using an encryption key; conceal the encrypted media file in the decoy media file to provide a output media file; and generate or receive access control information for controlling an access to the media file.
